(19) United States
(12) Patent Application Publication
(10) Pub. No.: US 2024/0229898 A1
(43) Pub. Date: Jul. 11, 2024

(54) Centerpost Thimble

(71) Applicant: Benjamin Zartman, Little Compton, RI (US)

(72) Inventor: Benjamin Zartman, Little Compton, RI (US)

(21) Appl. No.: 18/093,883

(22) Filed: Jan. 6, 2023

(51) Int. Cl. F16G 11/14

(52) U.S. Cl. CPC F16G 11/146

(57) ABSTRACT

The Centerpost Thimble, spliced into the end of a rope or cable, provides a strong and secure method of attachment to a ringbolt, padeye, or other fitting by capturing each end of a rope loop passed through said fitting. This provides a means to attach the cable which is nearly universal (limited only to what a loop can be led around), with a minimum of parts, and where metals do not contact one another.

### BACKGROUND OF THE INVENTION

In order to retain maximum strength in synthetic fiber cables, the end must be formed around a thimble and spliced back into the body of the cable to form a loop, or eye. Thimbles exist in various configurations, but common to all is a groove or trough around the outside perimeter which accommodates the cable. This not only protects the cable, but maintains the radius of the eye thus formed. The thimble is then attached by various methods, according to its design, to the load which the cable must bear, usually by means of a metal shackle, clevis pin, or as is becoming more common, a soft shackle or lashing made of fiber rope. The Centerpost Thimble provides an innovative, versatile way to secure the thimble to a ringbolt, bale, or other fitting by capturing the ends of a rope loop or strop that has been passed through the ringbolt or bale. This soft attachment method involves a minimum of parts, while keeping metals isolated from each other.

### SUMMARY

The present disclosure provides for a thimble designed to have a synthetic rope or cable spliced around it, with a strong post built in to the inside of the thimble that will accommodate a rope loop of sufficient size to match the load requirements of the cable, and thus secure the end of the cable to a padeye, ringbolt, or other fitting. The centerpost, in line with the axis of the load on the cable, prevents improper cross-loading or point-loading of the thimble, thus transferring the load fairly to the loop, which can articulate with reference to the padeye or deck fitting. This method isolates metal parts from each other, thus reducing noise, wear, and the dangerous cross-loading and point-loading sometimes associated with metal shackles in common thimbles.

The disclosure provides for a thimble that can be scaled to any dimension, such that the breaking load of whatever size of synthetic cable that will fit into the outer perimeter groove can be matched by that of a rope loop that will fit over the centerpost. The thimble can be machined, cast, or welded from a variety of metals to suit the load requirements.

There may be different embodiments of the thimble in which the outside shape has different proportions of either elongation, thickness, or depth of groove, as the cable, or the application, may require: the unique feature of the present disclosure is the fixed centerpost.

### BRIEF DESCRIPTION OF THE DRAWINGS

FIG. 1 depicts the thimble in a front view. The centerpost 1 is machined of the same stock as the thimble. Well-radiused edges 2 protect the attachment loop from fraying.

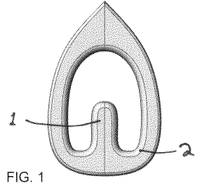

FIG. 2 depicts the thimble in a side view. The rounded groove 2 to receive the cable is scaled to accommodate cable diameter.

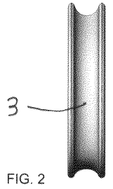

FIG. 3 depicts the thimble in an isometric view which shows the rounded groove 3, the centerpost 1 and the radiused inside edge 2.

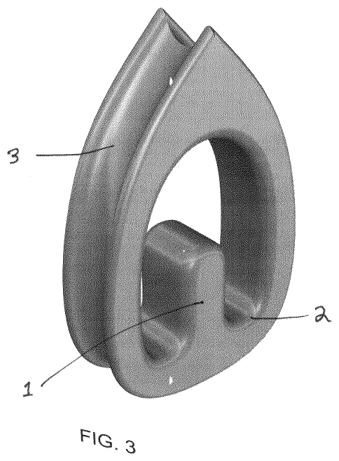

FIG. 4 depicts the thimble in use in isometric view. The cable 4 is spliced around the perimeter of the thimble inside the groove. The fiber loop 5 passes though a padeye 6 and the ends engage the centerpost 1 from opposite sides to keep the load centered.

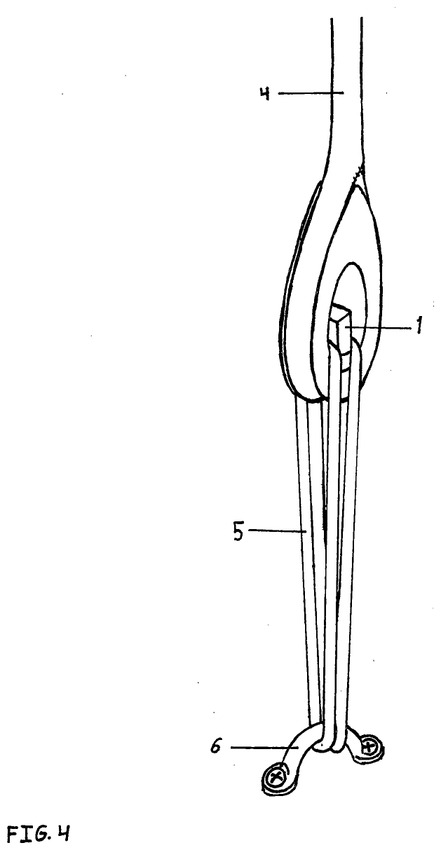

1. A rope thimble comprising:
1. A teardrop-shaped member with a groove around the perimeter to accommodate a rope or cable.
2. An oval hole through the center of the member with radiused edges to prevent rope damage.
3. A fixed post extending upward from the bottom of the hole, in line with the pull on the cable, of sufficient length that a loop of rope can be placed over it from either side, with enough clearance above to feed it over, and enough length below to support the two loops.
